(19) United States
(12) Patent Application Publication
(10) Pub. No.: US 2008/0263375 A1
(43) Pub. Date: Oct. 23, 2008

(54) Method And System For Managing Activities In A Battery Powered Device

(76) Inventors: Robert J. Sundstrom, Cary, NC (US); Robert P. Morris, Raleigh, NC (US)

Correspondence Address: SCENERA RESEARCH, LLC, 111 CORNING RD., SUITE 220, CARY, NC, 27518, US

(21) Appl. No.: 11/738,800

(22) Filed: Apr. 23, 2007

(51) Int. Cl. G06F 1/32

(52) U.S. Cl. 713/320

(57) ABSTRACT

A method for managing activities in a battery powered device includes receiving activity information, a start time that is different from a present time, and either a duration or an end time for performing the desired activity. The method also includes determining a required energy amount needed for performing the desired activity, determining an available energy amount for the battery powered device, determining a projected energy consumed by the battery powered device from the present time to the start time, and determining a residual energy of the battery powered device based on a difference of the device's available energy amount and a sum of the required energy and projected energy consumed by the battery powered device from the present time to the start time. An indication is provided that includes information relating to the desired activity and to whether the determined residual energy is sufficient to perform the desired activity.

### COPYRIGHT NOTICE

A portion of the disclosure of this patent document contains material which is subject to copyright protection. The copyright owner has no objection to the facsimile reproduction by anyone of the Patent and Trademark Office patent file or records, but otherwise reserves all copyright rights whatsoever.

### BACKGROUND

Battery powered mobile electronic devices, such as laptop computers, handheld personal digital assistants (PDAs), mobile and smart phones, digital cameras, and the like, offer mobility and a variety of utility applications and services to their respective users. Many devices include calendaring and/or “to-do list” applications that allow the user to schedule activities, such as phone calls, multimedia capture events, collaboration sessions and data backup operations, to be performed by the device at a future time.

While generally quite convenient and useful, the utility of these devices can be limited when the energy stored in the battery is depleted. For instance, when the energy level in the battery drops below a critical level, the device can become inoperative and automatically power off. The activities the device is performing are abruptly terminated, and the device cannot be used until the battery is either replaced or recharged.

To address this problem, some devices provide warnings when the energy level drops below a certain predetermined level. The warning can indicate to the user that the battery charge is low, that information should be saved, that the device will power down in a given number of seconds or minutes, etc. In addition, some devices can provide an icon indicating a current energy level of the device so that the user can continuously monitor the energy level. In some devices, the user can provide the predetermined energy level at which the warning will be issued.

While these warnings are useful to help prevent sudden interruptions and data loss, they only reflect the current state of the battery without regard to future activities. For instance, when the user has calendared to use the device to call a client in five (5) minutes, and the low energy warning issues and indicates the device will be powered off in one (1) minute, the user will be hard pressed to find a replacement battery or a power outlet within five (5) minutes so that the device can be used to call the client. Moreover, even if the energy level is sufficient to start a scheduled activity, there is no indication as to whether the energy level will be sufficient to complete the scheduled activity. Accordingly, in the middle of an important call with the client, a low power warning can be issued, forcing the user to end the call or to arrange another mode of continuing the conversation. In either case, the user is inconvenienced and placed in an embarrassing situation that can jeopardize the relationship between the user and the client.

### SUMMARY

Accordingly, a method and system for managing activities in a battery powered device are described. In one aspect, the method includes receiving activity information including an activity identifier associated with a desired activity, a start time that is different from a present time, and one of a duration and an end time for performing the desired activity using a battery powered device. The method also includes determining a required energy amount needed for performing the desired activity based on a predetermined power consumption value associated with the desired activity, determining an available energy amount for the battery powered device based on a present charge state of at least one battery in the battery powered device, determining a projected energy consumed by the battery powered device from the present time to the start time, where the projected energy includes a baseline energy needed to support baseline functions of the battery powered device, and determining a residual energy of the battery powered device based on a difference of the device's available energy amount and a sum of the required energy to perform the desired activity and the projected energy consumed by the battery powered device from the present time to the start time. An indication based on the residual energy determination is provided, where the indication includes information relating to the desired activity and to whether the determined residual energy is sufficient to perform the desired activity.

In another aspect, a system for managing activities in a battery powered device includes means for receiving activity information including an activity identifier associated with a desired activity, a start time that is different from a present time, and one of a duration and an end time for performing the desired activity using a battery powered device, means for determining a required energy amount needed for performing the desired activity based on a predetermined power consumption value associated with the desired activity, means for determining a projected energy consumed by the battery powered device from the present time to the start time, wherein the projected energy includes a baseline energy needed to support baseline functions of the battery powered device, means for determining a residual energy of the battery powered device based on a difference of an available energy amount for the battery powered device and a sum of the required energy to perform the desired activity and the projected energy consumed by the battery powered device from the present time to the start time; where the available energy amount is based on a present charge state of at least one battery in the battery powered device, and means for providing an indication based on the residual energy determination, where the indication includes information relating to the desired activity and to whether the determined residual energy is sufficient to perform the desired activity.

In yet another aspect, a system for managing activities in a battery powered device includes an activity planner component configured for receiving activity information including an activity identifier associated with a desired activity, a start time that is different from a present time, and one of a duration and an end time for performing the desired activity using a battery powered device, an activity energy forecaster component configured for determining a required energy amount needed for performing the desired activity based on a predetermined power consumption value associated with the desired activity, a supplemental energy forecaster component configured for determining a projected energy consumed by the battery powered device from the present time to the start time, where the projected energy includes a baseline energy needed to support baseline functions of the battery powered device, a residual energy determination unit configured for determining a residual energy of the battery powered device based on a difference of an available energy amount for the battery powered device and a sum of the required energy to perform the desired activity and the projected energy consumed by the battery powered device from the present time to the start time, where the available energy amount is based on a present charge state of at least one battery in the battery powered device, and an energy action manager component configured for providing an indication based on the residual energy determination, where the indication includes information relating to the desired activity and to whether the determined residual energy is sufficient to perform the desired activity.

### BRIEF DESCRIPTION OF THE DRAWINGS

The accompanying drawings provide visual representations which will be used to more fully describe the representative embodiments disclosed here and can be used by those skilled in the art to better understand the representative embodiments and their inherent advantages. In these drawings, like reference numerals identify corresponding elements, and:

FIG. 1A and FIG. 1B are block diagrams each illustrating an exemplary system for managing activities in a battery powered device according to two exemplary embodiments;

FIG. 2 is a block diagram illustrating an exemplary energy planning component according to one embodiment;

FIG. 3 is a flow diagram illustrating an exemplary process for managing activities in a battery powered device according to an exemplary embodiment; and

FIG. 4 is an exemplary icon representing an indication based on the residual energy determination according to one embodiment.

### DETAILED DESCRIPTION

Methods, systems and computer program products for managing activities in a battery powered device are disclosed. According to one embodiment, an energy planner component is configured to determine whether the available energy amount of one or more batteries of a battery powered device is sufficient to complete at least one activity that has been scheduled to be performed at a future time period. Based on the available energy amount, the energy required to complete the activity, and the time the activity is scheduled to start and end, the energy planner component is configured to provide an indication that includes information relating to the desired activity and to whether the device's available energy amount is sufficient to complete the scheduled activity.

In an exemplary embodiment, the indication is provided to the user of the battery powered device via a user interface. Thus, the user can take appropriate actions to ensure that the activity can be performed without interruption. For example, if the available energy amount is not sufficient, the user can purchase a new battery, recharge the battery or can arrange to perform the activity using another device.

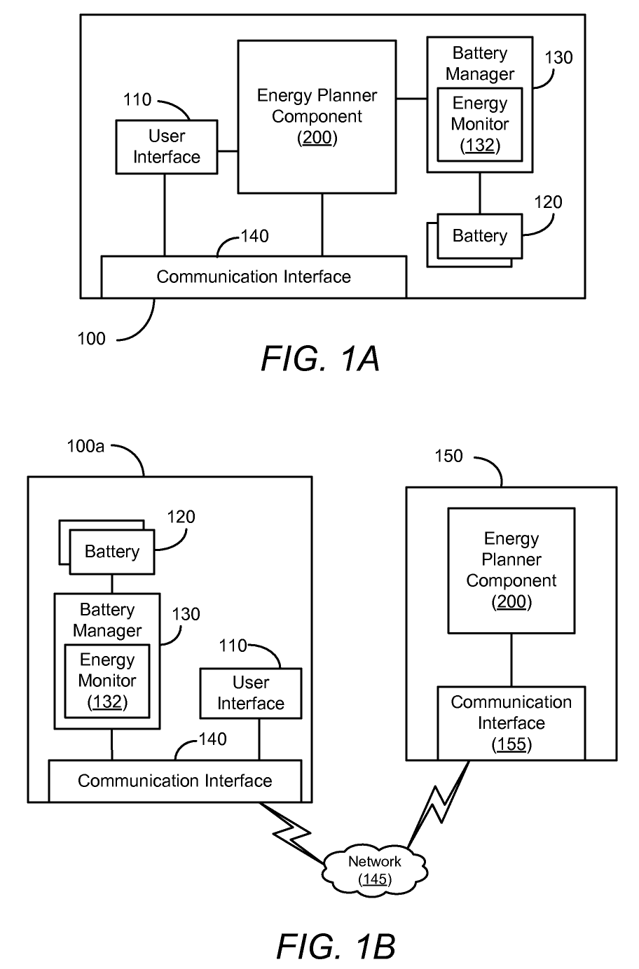

FIG. 1A is a block diagram illustrating an exemplary system for managing activities in a battery powered device according to one embodiment. In this embodiment, the system is integrated in a battery powered electronic device 100, such as a laptop computer, a PDA or a smart phone. The device 100 typically includes utility applications (not shown) that allow a user of the device 100 to perform activities that can involve data, places, other people or users, and events. For instance, typical applications can include an address book application, a calendaring application, applications that allow the user to make phone calls and capture images, video and audio data, and applications that support communications, such as electronic messaging, and the like. Moreover, the device 100 typically provides (not shown) a processor, operating system or control program, a network subsystem, input/output subsystems, and memory subsystems in order to provide an operating environment allowing the utility applications to operate.

In this embodiment, the device 100 includes at least one battery 120. Typically, a battery 120 stores energy, which is used to support the variety of activities offered by the battery powered device 100. The battery 120 can be a disposable or a rechargeable battery, such as a nickel-metal-hydride battery, a lithium ion battery, or other similar energy storage device. In yet other embodiments, the battery 120 can be an alternative energy source such as a fuel cell.

According to an exemplary embodiment, the device 100 includes a battery manager 130 that is configured to manage the distribution of the energy stored in the battery 120 to various components of the device 100. The battery manager 130 includes an energy monitor 132, in one embodiment, that is configured to determine the available energy amount for the device 100 based on the present charge state of the batteries 120. In one aspect, the energy monitor 132 tracks the voltage, current, temperature and/or other energy related parameters of the battery 120 to determine a State of Charge (SOC) of the battery 120, which is its available capacity expressed as a percentage of its rated capacity.

For example, the SOC of the battery 120 can be calculated by the energy monitor 132 based on an operation using at least one of an energy related parameter, such as an integral of the battery current, or the relations between the battery voltage, ambient temperature and the battery capacity, i.e., the charge and discharge characteristics. The available energy amount can be determined by multiplying the SOC of the battery 120 with its capacity rating, which in one embodiment is provided to the energy monitor 132 by the battery 120, by a configuration parameter, or by other suitable means.

According to an exemplary embodiment, the device 100 also includes an energy planner component 200 that is configured to determine whether the available energy amount is sufficient to complete at least one activity that has been scheduled to be performed at a future time period. Based on the available energy amount, the energy required to complete the activity, and the time the activity is scheduled to start and end, the energy planner component 200 is configured to provide an indication that includes information relating to the scheduled activity and to whether the device's available energy amount is sufficient to complete the scheduled activity. In one embodiment, the energy planner component 200 provides the indication to the user of the device 100 via a user interface 110.

The system illustrated in FIG. 1A is but one exemplary arrangement. In this arrangement, the functionality of the energy planner component 200 is integrated with that of the battery powered electronic device 100. Other arrangements can be implemented by those skilled in the art. For example, in another embodiment, illustrated in FIG. 1B, the functionality of the energy planner component 200 can be provided on a server 150 that is accessible by a battery powered electronic device 100a, such as a digital camera/phone, PDA, or the like, over a network 145, such as the Internet.

In this arrangement, the device 100a includes components for communicating with the server 150. For example, the device 100a can include a communication interface 140 coupled to the user interface 110 that allows the user to use the device 100a to communicate with the server 150 over a network 145 using one or more communication protocols. The device 100a includes at least one battery 120 coupled to the battery manager 130, both described above, which can be configured to transmit the determined available energy amount to the server 150 via the network 145 using the communication interface 140. In one embodiment, the communication interface 140 is configured to establish a secure transmission channel to the server 150 so that information can be sent securely.

In one embodiment, the server 150 can be a web server and the energy planner component 200 hosted therein can be a web application. The server 150 includes a communication interface 155 to transmit and receive data securely over the network 145. In an exemplary embodiment, the energy planner component 200 can be configured to receive or to retrieve the available energy amount from the device 100a via the network 145 using the communication interface 155, and to provide the indication to the user of the device 100a via the user interface 110 that supports a web browser. In this embodiment, the function of the energy planner component 200 can be provided by a third party application service provider (ASP) as a fee-based service. Moreover, the device 100a can be “thin” because the function of the energy planner component 200 is transferred to the server 150.

While two system embodiments have been described above, variations of these embodiments may be utilized and structural and functional modifications may be made without departing from the scope of the present disclosure.

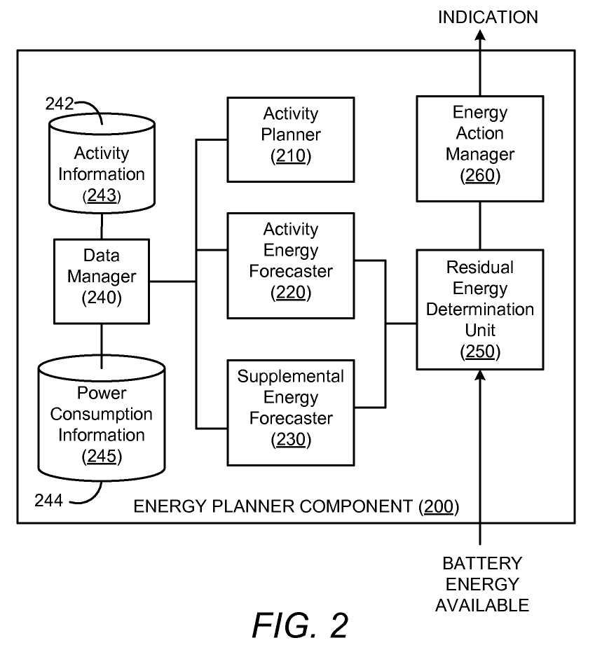

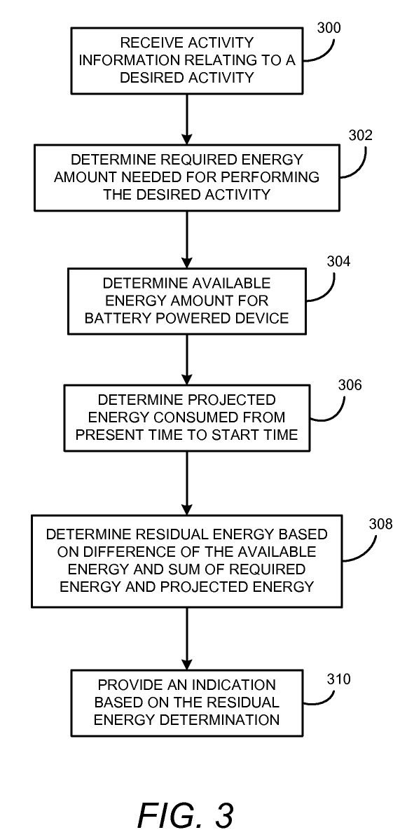

FIG. 2 is a block diagram that illustrates an exemplary energy planner component 200 according to one embodiment. As shown, the energy planner component 200 includes an activity planner component 210, an activity energy forecaster 220, a supplemental energy forecaster 230, a residual energy determination unit 250, and an energy action manager 260. In addition, the energy planner component 200 includes a data manager 240 that manages data stored in at least one data store 242, 244. In one embodiment, the stored data includes activity information 243 and power consumption information 245. The function of each component will now be described in conjunction with FIG. 3, which is a flowchart of an exemplary method for managing activities in a battery powered device, e.g., 100, using the energy planner component 200.

Referring to FIGS. 1, 2 and 3, the exemplary process begins when the energy planner component 200 receives activity information 243 relating to a desired activity to be performed using the battery powered device 100 (block 300). In one embodiment, the activity information 243 includes an activity identifier associated with the desired activity, a start time and either a duration or an end time for performing the desired activity using the battery powered device 100. The activity identifier can, in one embodiment, be a label associated with a type of activity. For example, the identifier, “DVDmovie,” can be associated with the activity of playing a video from a DVD, while the activity of playing a movie from a flash storage media can be associated with the identifier, “FlashMovie.”

The start time is a time in the future. That is, the start time is different from a present time. Accordingly, the desired activity can also be considered a scheduled activity because it is to be performed at a scheduled time in the future. The start time can be a specific date and time in one embodiment. In other embodiments, the start time can be a range of times that include an earliest start time and a latest start time. In one embodiment when the start time is not specified, a default start time, e.g., one hour from the present time, can be used.

Similarly, the end time can be a specific date and time or a range from an earliest end time to a latest end time. In addition, the duration can range from a shortest duration to a longest duration. In some embodiments, the duration and/or end time can also be set to default values, e.g., 30 minutes.

According to an exemplary embodiment, the energy planner component 200 includes means for receiving the activity information 243 relating to the desired activity. For example, the activity planner component 210 can be configured to receive the activity information 243. The activity planner component 210 can, in one embodiment, receive the activity information 243 from the user of the battery powered device 100 through the user interface 110. In another embodiment, the activity information 243 can be received from an administrator through a network to which the battery powered device 100 is communicatively connected. For example, the battery powered device 100 can include a communication interface 140 that enables the device 100 to send and receive information to other networked devices. In one embodiment, the activity planner component 210 can support at least one of a calendar, a to-do or task list, and a workflow or project schedule.

In an exemplary embodiment, the activity planner component 210 can use the data manager 240 to store the received activity information 243 in the data store 242. Likewise, the activity planner component 210 can use data manager 240 to retrieve the activity information 243 when needed. For example, the activity information 243 for a particular desired activity can be retrieved when the corresponding start time is within a predetermined time period, e.g., 60 minutes, of the present time.

After the activity information 243 is received, a required energy amount needed for performing the desired activity is determined (block 302). In an exemplary embodiment, the energy planner component 200 includes a means for determining the required energy amount based on a predetermined power consumption value associated with the desired activity. For example, the activity energy forecaster component 220 can be configured to perform this function.

According to one embodiment, the activity energy forecaster component 220 uses the activity information received by the activity planner component 210 to forecast the required energy amount needed to run the desired activity for the duration, which is either specified or is determined from the start time and the end time. The activity energy forecaster component 220 can make this determination when the activity planner component 210 receives the activity information 243, when the activity planner component 210 retrieves the activity information 243 from the data store 242, e.g., in response to a request from the user, and/or periodically in anticipation of performing the desired activity.

As stated above, the power consumption information 245 can be stored in a data store 244 that is managed by the data manager 240. In one embodiment, the power consumption information is associated with the battery powered device 100 and/or the user, and includes a plurality of activity identifiers associated with a plurality of desired activities. Corresponding to each activity identifier is a predetermined power consumption value expressed as the energy used over a given time period.

In one embodiment, the power consumption values are predetermined by performing an activity identified by an activity identifier using the battery powered device 100 or using a device with similar power characteristics, and measuring the power consumed by the battery powered device 100. Alternatively or additionally, the power consumption value for an activity can be predicted from a model of the resources used to perform the activity or from a simulation of the activity performed. These power measurements/predictions can then be provided to the energy planner component 200 by the device manufacturer or software developer, the user or the user's organization, or a third party. In other embodiments, the power consumption values can be self-determined by the battery powered device 100 by measuring an average rate of energy usage over a period of time when the activity is being performed by the battery powered device 100.

According to an exemplary embodiment, the activity energy forecaster component 220 uses the activity identifier associated with the desired activity to retrieve the corresponding predetermined power consumption value from the data store 244 via the data manager 240. The required energy amount needed to perform the desired activity for the duration is then determined, in one embodiment, by multiplying the predetermined power consumption value by the duration, which is either specified or calculated from the start time and the end time. In one embodiment when the duration is expressed as a range of time values, the activity energy forecaster component 220 can determine a range of required energy amounts corresponding to the range of duration times.

In one embodiment, the predetermined power consumption values do not take into consideration the energy amount needed for supporting the basic functions of the battery powered device 100. In other words, the predetermined power consumption values reflect an incremental power consumption above a baseline power consumed when the device 100 is powered on, but not running applications. When such is the case, the activity energy forecaster component 220 can determine the energy amount needed to support the basic functions of the battery powered device 100 for the duration of the desired activity, and can add this baseline energy to the previously determined required energy amount.

According to the exemplary method, an available energy amount for the battery powered device 100 is also determined (block 304). The available energy amount is based on the present charge state of the battery or batteries 120 in the battery powered device 100. As discussed above, the energy monitor 132 in the battery manager 130 tracks the voltage, current, temperature and/or other energy related parameters of the batteries 120 to determine the charge state of the batteries 120. The available energy amount can then be determined by multiplying the charge state of the batteries 120 with their respective capacity ratings.

The exemplary method further includes determining a projected energy consumed by the battery powered device 100 from the present time to the start time of the desired activity (block 306). The projected energy, in one embodiment, includes a baseline energy needed to support baseline functions of the battery powered device 100 from the present time to the start time. For example, for a mobile phone, the projected energy can be based on the power consumed while the phone is in a standby mode, while for a laptop computer, the projected energy can be based on the power consumed while the laptop is powered on, but not running any applications.

In an exemplary embodiment, the energy planner component 200 includes a means for determining the projected energy consumed by the battery powered device from the present time to the start time. For example, the supplemental energy forecaster component 230 can be configured to perform this function. In one embodiment, the supplemental energy forecaster component 230 can retrieve a predetermined power consumption value corresponding to the battery powered device's baseline functions from the data store 244 via the data manager 240. The projected energy is then determined, in one embodiment, by multiplying the retrieved predetermined power consumption value by the time difference between the present time and the start time. In another embodiment when the start time is expressed as a range of time values, the supplemental energy forecaster component 230 can determine a range of projected energy values corresponding to the range of start times.

In another embodiment, the data store 244 stores a plurality of power consumption values corresponding to the battery powered device's baseline functions for different time periods. For example, a power management system on a laptop computer may be configured to reduce the power to certain components, such as the hard drive or display, after predetermined periods of inactivity. In this embodiment, the supplemental energy forecaster component 230 can determine the time period between the present time and the start time and retrieve the baseline power consumption value(s) corresponding to that time period. In this manner, the determined projected energy can be a better estimate of the energy that the device 100 will consume over a period of time when no other user actions are taken.

In yet another embodiment, the supplemental energy forecaster component 230 can be configured to detect at least one intervening activity having a start time that is before the start time associated with the desired activity. In one embodiment, the supplemental energy forecaster component 230 can use the data manager 240 to query the activity information data store 242 to make this determination. In this embodiment, when such an intervening activity is detected, the supplemental energy forecaster component 230 can determine the energy required to perform the intervening activity, and then determine the projected energy by adding the energy required to perform the intervening activity to the baseline energy.

For example, the desired activity can have a 4:00 p.m. start time and the present time is 2:00 p.m. The supplemental energy forecaster component 230 can query the activity information data store 242 and detect an intervening activity scheduled for 3:00 p.m. In response to this detection, the supplemental energy forecaster component 230 can determine the energy required to perform the intervening activity. In one embodiment, the supplemental energy forecaster component 230 can make this determination by multiplying a power consumption value corresponding to the intervening activity by the duration of the intervening activity. Alternatively, in another embodiment, the supplemental energy forecaster component 230 can use an average value of the energy required for the intervening activity, where the average value is determined from historical data related to the activity. The projected energy is then determined by adding the energy required to perform the intervening activity to the baseline energy needed to support baseline functions of the battery powered device for two (2) hours.

Once the required energy amount needed for performing the desired activity, the available energy amount, and the projected energy are determined, a residual energy of the battery powered device is determined (block 308). In one embodiment, the residual energy determination is based on a difference of the device's available energy amount and a sum of the required energy to perform the desired activity and the projected energy consumed by the device 100 from the present time to the start time.

In an exemplary embodiment, the energy planner component 200 includes a means for determining the residual energy of the battery powered device 100. For example, the residual energy determination unit 250 can be configured to perform this function. In one embodiment, the residual energy determination unit 250 receives the required energy amount needed for performing the desired activity from the activity energy forecaster component 220, the available energy amount from the energy monitor 132, and the projected energy from the supplemental energy forecaster 230. The residual energy is then determined, in one embodiment, by subtracting the sum of the required energy amount and the projected energy from the available energy amount.

In one embodiment, the activity information related to the desired activity includes a range of start times that include an earliest start time and a latest start time, a range of end times from an earliest end time to a latest end time, and/or a range of durations including a shortest duration to a longest duration. In this embodiment, the residual energy determination unit 250 can receive a plurality of energy measures based on the range of start times, the range of end times, and/or the range of durations. For example, the residual energy determination unit 250 can receive a plurality of required energy amounts corresponding to the range of duration times, and a plurality of projected energy values corresponding to the range of start times. The residual energy determination unit 250 can then use the plurality of energy measures to determine a plurality of residual energy measures that comprise the residual energy of the battery powered device 100.

When the determined residual energy is greater than zero or a predetermined threshold value, the battery powered device 100 has sufficient energy to operate from the present time to the start time of the desired activity and to perform the desired activity from the start time through the duration to the end time. The opposite is the case when the residual energy is less than zero or the predetermined threshold value.

Once the residual energy is determined, an indication based on the residual energy determination is provided (block 310). The indication, in one embodiment, includes information relating to the desired activity and to whether the determined residual energy is sufficient to perform the desired activity. According to an exemplary embodiment, the energy planner component 200 includes a means for providing the indication based on the residual energy determination. For example, the energy action manager component 260 can be configured to perform this function.

In one embodiment, the energy action manager component 260 provides the indication to the user of the battery powered device 100 via the device's user interface 110. The manner in which the indication is presented can depend on the activity, the residual energy determination, the capabilities of the device 100, and/or user preferences, for example. The indication can be presented via the user interface 110 that supports at least one of a text message, a popup dialog, an icon, an audio message, a web browser, and a warning alarm. The indication may be continuously presented, periodically presented, and/or presented upon request of the user. In one embodiment, the energy action manager component 260 can present an indication, e.g., issue a warning, when the residual energy falls below a predetermined threshold value.

For example, when the battery powered device 100 is a digital camera and the user has scheduled an image capture activity to capture 25 images starting at 4:00 p.m., the energy action manager component 260 can provide one of two indications based on the residual energy determination:
1. “Sufficient battery energy is currently available for your image capture activity scheduled at 4:00 p.m.”
2. “There is not sufficient battery energy currently available for your image capture activity scheduled at 4:00 p.m.”
   In this example, the indication is a message that can be presented as a text message, an audio message, or in a popup dialog box. Alternatively, or additionally, the indication can be an icon that conveys the message. For example, an icon depicting a camera that represents the image capture activity can be presented in a display with a green “check” next to the camera to convey the message that the residual energy is sufficient or a red “X” next to the camera to convey the message that the residual energy is not sufficient.

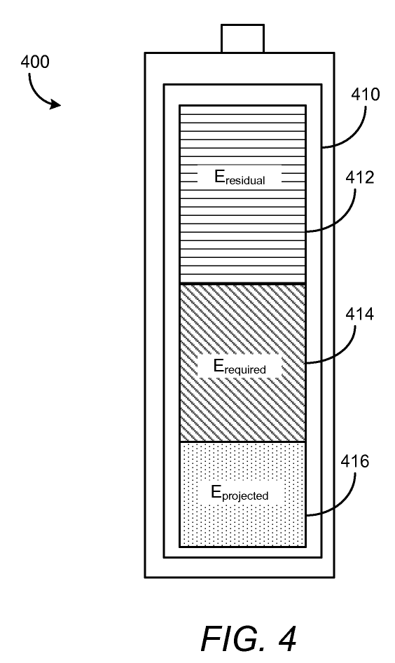

In another example, illustrated in FIG. 4, a battery icon 400 that depicts the determined energy measures can be presented. In this example, a gray region 410 represents the battery's present charge state which is related to the available energy amount. Within the gray region 410, the projected energy is represented by a dotted region 416, the required energy amount is represented by a diagonal cross-hatched region 414, and the residual energy is represented by a horizontal cross-hatched region 412. Accordingly, in this example, the battery icon 400 conveys the message that the residual energy is sufficient to perform the desired activity as well as other activities.

In some embodiments, the indication can also suggest under what conditions the desired activity can be performed in light of the residual energy determination. For example, when the start time is provided as a range, the energy action manager 260 can provide an indication suggesting a latest start time or latest start time range in which the battery powered device 100 can be used to perform the desired activity. In another embodiment, when the determined residual energy is not sufficient to perform the desired activity, the energy action manager 260 can provide an indication that suggests changing the start time, and/or changing the duration of the desired activity. For example, the user may wish to reserve sufficient energy for a 30-minute phone call at 4:00 pm. When the determined residual energy is not sufficient for the 30-minute call, the indication can inform the user of this and also indicate that the residual energy is sufficient to complete a 15 minute call.

According to an exemplary embodiment, the energy action manager 260, in addition to providing the indication to the user, is also configured to provide the indication to a messaging service for providing a corresponding indication to other devices, e.g., so that users of the other devices 100 can also receive the indication. For example, in one embodiment, the energy action manager 260 can publish the indication to a subscription service using a publish-subscribe protocol, such as a presence protocol, so that subscribers to the service can receive notifications including the indication. In this embodiment, the information relating to whether the determined residual energy is sufficient to perform the desired activity can be a status associated with the desired activity, which can be a principal of the reported status tuple. A subscriber can receive a notification pursuant to a subscription to the status tuple or pursuant to a directed publish/notify command. In this manner, a participant/subscriber in a scheduled call can receive an indication identifying the activity, e.g., the scheduled call, and information relating to whether the determined residual energy of the device used by another participant in the call is sufficient to perform the planned activity. In one embodiment, reporting can be limited to providing a warning to the other device 100 that the planned activity may not be able to be finished.

According to other embodiments, the energy action manager 260 can implement other actions based on the residual energy determination. In one embodiment, the energy action manager 260 can change a present power consumption state of the battery powered device 100 in order to conserve the available energy amount for the desired activity. For example, the energy action manager 260 can terminate energy consuming activities, and/or cause the device 100 to enter an operational mode that consumes less energy, such as a hibernation mode, a standby mode, or a power off mode. In another embodiment, the energy action manager 260 can close one or more applications running on the battery powered device 100 and/or prevent an application from being launched based on the residual energy determination. For example, the energy action manager 260 can prevent the user from listening to music or surfing the web using the battery powered device 100 when the residual energy is below a specified threshold.

In another embodiment, the energy action manager 260 can provide an updated indication relating to the desired activity when the battery powered device 100 is used to perform a second activity during a time prior to the start time and/or when a request to perform the second activity during a time prior to the start time is received. In this embodiment, the updated indication can include information relating to the desired activity, the second activity, whether the residual energy is sufficient to perform the desired activity and the second activity, and/or an amount of time the second activity can be performed without jeopardizing the desired activity.

For example, a 30-minute call using a smart phone is scheduled to start at 4:00 p.m. and the present time is 2:00 p.m. When the user launches an application on the smart phone to listen to music or surf the web, the energy action manager 260 can provide an updated indication including the message, “you have sufficient energy remaining in your battery to listen for 20 minutes and still have adequate energy for your scheduled 30-minute call,” or, “you must close your browser now to reserve battery energy for your scheduled call.”

In another embodiment, the energy planner component 200 can provide responses to user queries, such as, “Can I watch a video without endangering the activity?” The energy planner component 200 can determine a hypothetical residual energy and provide an answer to the user's query based on the determined hypothetical residual energy determination.

Through aspects of the embodiments described, scheduled activities using a battery powered device can be managed. It should be understood that the various components illustrated in the figures represent logical components that are configured to perform the functionality described herein and may be implemented in software, hardware, or a combination of the two. Moreover, some or all of these logical components may be combined and some may be omitted altogether while still achieving the functionality described herein.

To facilitate an understanding of exemplary embodiments, many aspects are described in terms of sequences of actions that can be performed by elements of a computer system. For example, it will be recognized that in each of the embodiments, the various actions can be performed by specialized circuits or circuitry (e.g., discrete logic gates interconnected to perform a specialized function), by program instructions being executed by one or more processors, or by a combination of both.

Moreover, the sequences of actions can be embodied in any computer-readable medium for use by or in connection with an instruction execution system, apparatus, or device, such as a computer-based system, processor containing system, or other system that can fetch the instructions from a computer-readable medium and execute the instructions.

As used herein, a “computer-readable medium” can be any medium that can contain, store, communicate, propagate, or transport instructions for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, a portable compact disc read-only memory (CDROM), a portable digital video disc (DVD), a wired network connection and associated transmission medium, such as an ETHERNET transmission system, and/or a wireless network connection and associated transmission medium, such as an IEEE 802.11(a), (b), or (g) or a BLUETOOTH transmission system, a wide-area network (WAN), a local-area network (LAN), the Internet, and/or an intranet.

Thus, the subject matter described herein can be embodied in many different forms, and all such forms are contemplated to be within the scope of what is claimed.

It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for managing activities in a battery powered device, the method comprising:
receiving activity information including an activity identifier associated with a desired activity, a start time, and one of a duration and an end time for performing the desired activity using a battery powered device, wherein the start time is different from a present time;
determining a required energy amount needed for performing the desired activity based on a predetermined power consumption value associated with the desired activity;
determining an available energy amount for the battery powered device based on a present charge state of at least one battery in the battery powered device;
determining a projected energy consumed by the battery powered device from the present time to the start time, wherein the projected energy includes a baseline energy needed to support baseline functions of the battery powered device;
determining a residual energy of the battery powered device based on a difference of the device's available energy amount and a sum of the required energy to perform the desired activity and the projected energy consumed by the battery powered device from the present time to the start time; and
providing an indication based on the residual energy determination, wherein the indication includes information relating to the desired activity and to whether the determined residual energy is sufficient to perform the desired activity.

2. The method of claim 1 wherein receiving the activity information includes receiving the activity information from at least one of a user of the battery powered device via a user interface and from another device via a network.

3. The method of claim 1 wherein after receiving the activity information, the method further includes storing the activity information in a data store and retrieving the activity information when the start time is within a predetermined time period of the present time.

4. The method of claim 1 further comprising storing power consumption information associated with the battery powered device in a data store, wherein the power consumption information includes a plurality of activity identifiers associated with a plurality of desired activities and, corresponding to each activity identifier, a predetermined power consumption value.

5. The method of claim 4 wherein determining the required energy amount includes:
using the activity identifier associated with the desired activity to retrieve the corresponding predetermined power consumption value; and
multiplying the predetermined power consumption value by one of the duration of the desired activity and a difference between the start time and the end time of the desired activity.

6. The method of claim 1 wherein determining the required energy amount includes:
multiplying the predetermined power consumption value by one of the duration of the desired activity and a difference between the start time and the end time of the desired activity; and
adding an energy amount needed for supporting baseline functions of the battery powered device for the duration of the desired activity.

7. The method of claim 1 wherein determining the projected energy consumed further includes detecting at least one other scheduled activity having a start time that is before the start time associated with the desired activity, determining an energy amount required to perform the at least one other scheduled activity, and adding the energy amount required to perform the at least one other scheduled activity to the baseline energy.

8. The method of claim 1 wherein providing the indication includes presenting the indication to a user of the battery powered device via a user interface that supports at least one of an icon, a popup dialog box, a text message, an audio message and a warning alarm.

9. The method of claim 1 further including providing the indication to a messaging service for providing a corresponding indication to another device.

10. The method of claim 1 further including changing a present power consumption state of the battery powered device based on the residual energy determination.

11. The method of claim 10 wherein changing the power consumption state includes at least one of terminating energy consuming activities and entering an operational mode that consumes less energy including one of a hibernation mode, a standby mode, and a power off mode.

12. The method of claim 1 further including at least one of closing an application and preventing an application from being launched based on the residual energy determination.

13. The method of claim 1 further including providing an updated indication relating to the desired activity when one of a second activity is performed during a time prior to the start time and a request to perform a second activity during a time prior to the start time is received, wherein the updated indication includes information relating to at least one of the desired activity, the second activity, whether the residual energy is sufficient to perform the desired activity and the second activity, and an amount of time the second activity can be performed.

14. The method of claim 1 wherein the activity information further includes at least one of an earliest start time, a latest start time, an earliest end time, a latest end time, a shortest duration, and a longest duration, and wherein determining the residual energy of the battery powered device includes:
receiving a plurality of energy measures based on at least one of a plurality of start times ranging from and including the earliest start time to the latest start time, a plurality of end times ranging from and including the earliest end time and the latest end time, and a plurality of durations ranging from and including the shortest duration to the longest duration; and
using the plurality of energy measures to determine the residual energy of the battery powered device, wherein the determined residual energy includes a plurality of residual energy measures based on the plurality of energy measures.

15. The method of claim 1 wherein when the determined residual energy is insufficient to perform the desired activity, the method further includes changing at least one of the start time and one of the duration and the end time.

16. The method of claim 1 wherein providing the indication includes suggesting a latest start time range in which the battery powered device can be used to perform the desired activity.

17. The method of claim 1 wherein providing the indication includes issuing a warning when the determined residual energy is below a predetermined threshold value.

18. A system for managing activities in a battery powered device, the system comprising:
means for receiving activity information including an activity identifier associated with a desired activity, a start time, and one of a duration and an end time for performing the desired activity using a battery powered device, wherein the start time is different from a present time;
means for determining a required energy amount needed for performing the desired activity based on a predetermined power consumption value associated with the desired activity;
means for determining a projected energy consumed by the battery powered device from the present time to the start time, wherein the projected energy includes a baseline energy needed to support baseline functions of the battery powered device;
means for determining a residual energy of the battery powered device based on a difference of an available energy amount for the battery powered device and a sum of the required energy to perform the desired activity and the projected energy consumed by the battery powered device from the present time to the start time; wherein the available energy amount is based on a present charge state of at least one battery in the battery powered device; and
means for providing an indication based on the residual energy determination, wherein the indication includes information relating to the desired activity and to whether the determined residual energy is sufficient to perform the desired activity.

19. A system for managing activities in a battery powered device, the system comprising:
an activity planner component configured for receiving activity information including an activity identifier associated with a desired activity, a start time, and one of a duration and an end time for performing the desired activity using a battery powered device, wherein the start time is different from a present time;
an activity energy forecaster component configured for determining a required energy amount needed for performing the desired activity based on a predetermined power consumption value associated with the desired activity;
a supplemental energy forecaster component configured for determining a projected energy consumed by the battery powered device from the present time to the start time, wherein the projected energy includes a baseline energy needed to support baseline functions of the battery powered device;
a residual energy determination unit configured for determining a residual energy of the battery powered device based on a difference of an available energy amount for the battery powered device and a sum of the required energy to perform the desired activity and the projected energy consumed by the battery powered device from the present time to the start time, wherein the available energy amount is based on a present charge state of at least one battery in the battery powered device; and
an energy action manager component configured for providing an indication based on the residual energy determination, wherein the indication includes information relating to the desired activity and to whether the determined residual energy is sufficient to perform the desired activity.

20. The system of claim 19 wherein the system is provided in the battery powered device.

21. The system of claim 19 wherein the battery powered device includes at least one battery and a battery manager component configured for determining the available energy amount for the battery powered device and for transmitting the determined available energy amount to the residual energy determination unit.

22. The system of claim 19 wherein the activity planner component is configured for receiving the activity information from at least one of a user of the battery powered device via a user interface and from another device via a network.

23. The system of claim 19 further comprising at least one data store for storing activity information and power consumption information associated with the battery powered device, wherein the power consumption information includes a plurality of activity identifiers associated with a plurality of desired activities and, corresponding to each activity identifier, a predetermined power consumption value.

24. The system of claim 19 wherein the activity planner component is provided in the battery powered device and at least one of the activity energy forecaster component, the residual energy determination unit, and the energy action manager component is provided in at least one remote device.

25. The system of claim 19 wherein the energy action manager component is configured for providing the indication to a user interface in the battery powered device so that the indication can be presented to a user of the battery powered device.

26. The system of claim 19 wherein the energy action manager component is configured for providing the indication to a messaging service for providing a corresponding indication to another device.

27. The system of claim 19 wherein the energy action manager component is further configured for changing a present power consumption state of the battery powered device based on the residual energy determination by at least one of terminating energy consuming activities operating on the battery powered device and causing the battery powered device to enter an operational mode that consumes less energy including one of a hibernation mode, a standby mode, and a power off mode.

28. The system of claim 19 wherein the supplemental energy forecaster component is further configured for detecting at least one scheduled activity having a start time that is before the start time associated with the desired activity, determining an energy required to perform the at least one scheduled activity, and adding the energy required to perform the at least one scheduled activity to the baseline energy.

29. The system of claim 19 wherein the energy action manager component is configured for at least one of closing an application and preventing an application from being launched based on the residual energy determination.

30. The system of claim 19 wherein the energy action manager component is configured for providing an updated indication relating to the desired activity when one of a second activity is performed during a time prior to the start time and a request to perform a second activity during a time prior to the start time is received, wherein the updated indication includes information relating to at least one of the desired activity, the second activity, whether the residual energy is sufficient to perform the desired activity and the second activity, and an amount of time the second activity can be performed.

31. The system of claim 19 wherein the activity information further includes at least one of an earliest start time, a latest start time, an earliest end time, a latest end time, a shortest duration, and a longest duration, and wherein the residual energy determination unit is further configured for receiving a plurality of energy measures based on at least one of a plurality of start times ranging from and including the earliest start time to the latest start time, a plurality of end times ranging from and including the earliest end time and the latest end time, and a plurality of durations ranging from and including the shortest duration to the longest duration, and for using the plurality of energy measures to determine the residual energy of the battery powered device, wherein the determined residual energy includes a plurality of residual energy measures based on the plurality of energy measures.

32. The method of claim 19 wherein the energy action manager component is configured for changing at least one of the start time and one of the duration and the end time when the determined residual energy is insufficient to perform the desired activity.

33. The system of claim 19 wherein the energy action manager component is configured for suggesting a latest start time range in which the battery powered device can be used to perform the desired activity.

34. The system of claim 19 wherein the energy action manager component is configured for issuing a warning when the determined residual energy is below a predetermined threshold value.

35. A computer readable medium containing a computer program, executable by a machine, for managing activities in a battery powered device, the computer program comprising executable instructions for:
receiving activity information including an activity identifier associated with a desired activity, a start time, and one of a duration and an end time for performing the desired activity using a battery powered device, wherein the start time is different from a present time;
determining a required energy amount needed for performing the desired activity based on a predetermined power consumption value associated with the desired activity;
determining an available energy amount for the battery powered device based on a present charge state of at least one battery in the battery powered device;
determining a projected energy consumed by the battery powered device from the present time to the start time, wherein the projected energy includes a baseline energy needed to support baseline functions of the battery powered device;
determining a residual energy of the battery powered device based on a difference of the device's available energy amount and a sum of the required energy to perform the desired activity and the projected energy consumed by the battery powered device from the present time to the start time; and
providing an indication based on the residual energy determination, wherein the indication includes information relating to the desired activity and to whether the determined residual energy is sufficient to perform the desired activity.
